(19) United States
(12) Patent Application Publication
(10) Pub. No.: US 2018/0210551 A1
(43) Pub. Date: Jul. 26, 2018

(54) DISPLAY MANIPULATION DEVICE

(71) Applicant: DENSO CORPORATION, Kariya-city, Aichi-pref. (JP)

(72) Inventor: Nozomi Kitagawa, Kariya-city, Aichi-pref. (JP)

(21) Appl. No.: 15/745,963

(22) PCT Filed: Jun. 21, 2016
(86) PCT No.: PCT/JP2016/002985

§ 371 Date: Jan. 18, 2018

(30) Foreign Application Priority Data
Jul. 23, 2015 (JP) 2015-145926

(51) Int. Cl. G06F 3/01; G06F 3/0481; G06F 3/0484; G06F 3/0488

(52) U.S. Cl. CPC G06F 3/016; G06F 3/04815; G06F 3/0488; G06F 3/04847; G06F 3/04842

(57) ABSTRACT

A display manipulation device, which enables an operator to manipulate an image of manipulation target displayed in midair, includes a midair display device, a position identifier, and a tactile sense provider. The midair display device displays the image of manipulation target in a virtual aerial display region defined in midair. The position identifier identifies a position of a manipulation body in the aerial display region. The tactile sense provider provides tactile stimulus to the manipulation body in a non-contact manner based on the identified position of the manipulation body when the manipulation body touches the image of manipulation target. The image of manipulation target is displayed to induce a state of the manipulation body so that a high sensitivity portion of the manipulation body, which is highly sensitive to the tactile stimulus, faces a direction susceptible to the tactile stimulus provided by the tactile sense provider.

### CROSS REFERENCE TO RELATED APPLICATION

This application is based on Japanese Patent Application No. 2015-145926 filed on Jul. 23, 2015, the disclosure of which is incorporated herein by reference.

### TECHNICAL FIELD

The present disclosure relates to a display manipulation device that enables an operator to manipulate an image of a manipulation target which is projected to be displayed in midair.

### BACKGROUND ART

Up to now, for example, Patent Literature 1 discloses a tactile sense providing device that provides a stimulus caused by ultrasonic waves to a person skin, to thereby cause a person to feel a tactile stimulus as if touching an object. Such a tactile sense providing device is combined with a display device that displays a three-dimensional image by midair projection display technique, and an infrared camera that identifies a position of a finger or the like for manipulating the three-dimensional image. Such a combination forms an interaction system that is capable of manipulating a virtual object by hand with tactile sensation.

### PRIOR ART LITERATURE

### Patent Literature

Patent Literature 1: JP 5343946 B

### SUMMARY OF INVENTION

In a process of developing the interaction system as disclosed in Patent Literature 1, the inventors of the present disclosure have found that manipulation body, such as operator's finger has a high sensitivity portion with a high sensitivity to a tactile stimulus and a low sensitivity portion with a low sensitivity. It is desirable that the tactile stimulus is provided to the high sensitivity portion in order to ensure that the finger touching the image displayed in midair feels the virtual tactile sensation.

However, the tactile sense providing device cannot constantly provide the tactile stimulus to the high sensitivity portion of the finger which manipulates the image from the viewpoint of a positional relationship between the operator and the image displayed in midair. For that reason, there may be a situation where it is difficult for the operator to feel the tactile stimulus depending on a state of a manipulation body such as the finger which manipulates the image.

The present disclosure has been made in view of the above difficulties, and an object of the present disclosure is to provide a display manipulation device that is capable of ensuring that a manipulation feeling is provided to an operator who manipulates an image of an insubstantial manipulation target which is screenlessly displayed in midair.

According to an aspect of the present disclosure, a display manipulation device, which enables an operator to manipulate an image of a manipulation target displayed in midair, includes a midair display device, a position identifier, and a tactile sense provider. The midair display device displays the image of the manipulation target in a virtual aerial display region defined in midair. The position identifier identifies a position of a manipulation body of the operator in the aerial display region. The tactile sense provider provides a tactile stimulus to the manipulation body in a non-contact manner based on the identified position of the manipulation body when the position identifier determines that the manipulation body touches the image of the manipulation target. The manipulation body of the operator has a high sensitivity portion, which is highly sensitive to the tactile stimulus. The image of the manipulation target is displayed to induce a state of the manipulation body so that the high sensitivity portion of the manipulation body faces a direction susceptible to the tactile stimulus provided by the tactile sense provider.

According to the present disclosure, the display manipulation device can control the high sensitivity portion high in the sensitivity to the tactile stimulus in an operator's manipulation body to orient a direction which is more susceptible to the tactile stimulus caused by the tactile sense provider by guiding the high sensitivity portion to an image of a manipulation target displayed in midair. Therefore, even with the tactile stimulus provided in a non-contact manner, the certainty that the operator feels the tactile stimulus is increased. According to the above configuration, the display manipulation device can reliably provide the manipulation feeling to the operator who manipulates the image of the insubstantial manipulation target which is displayed in midair.

### BRIEF DESCRIPTION OF DRAWINGS

The above and other objects, features and advantages of the present invention will become more apparent from the following detailed description made with reference to the accompanying drawings. In the drawings:

FIG. 1 is a diagram showing a layout around a driver's seat of a vehicle on which a display manipulation device is mounted;

FIG. 2 is a diagram showing a positional relationship of each configuration of the display manipulation device;

FIG. 3 is a block diagram showing an electric configuration of a display manipulation device according to a first embodiment of the present disclosure;

FIG. 4 is a flowchart showing details of a tactile sense control process implemented by a tactile control unit;

FIG. 5 is a flowchart showing details of the image control process implemented by a display control unit;

FIG. 6 is a diagram showing a display mode of an image of a manipulation target and a state of a finger guided by the image according to the first embodiment;

FIG. 7 is a diagram showing a display mode of an image of a manipulation target and a state of a finger guided by the image according to a second embodiment of the present disclosure;

FIG. 8 is a diagram showing a display mode of an image of a manipulation target and a state of a finger guided by the image according to a third embodiment of the present disclosure;

FIG. 9 is a block diagram showing an electric configuration of a display manipulation device according to the third embodiment;

FIG. 10 is a diagram showing a display mode of an image of a manipulation target and a state of a hand guided by the image according to a fourth embodiment of the present disclosure;

FIG. 11 is a block diagram showing an electric configuration of a display manipulation device according to the fourth embodiment;

FIG. 12 is a diagram showing a display mode of an image of a manipulation target and a state of a finger guided by the image according to a fifth embodiment of the present disclosure;

FIG. 13 is a diagram illustrating the operation of a moving mechanism associated with rotation operation of a dial;

FIG. 14 is a flowchart showing details of a tactile sense control process implemented by a tactile control unit of the fifth embodiment;

FIG. 15 is a block diagram showing an electric configuration of a display manipulation device according to the fifth embodiment;

FIG. 16 is a diagram showing a display mode of an image of a manipulation target and a state of a finger guided by the image according to a sixth embodiment of the present disclosure;

FIG. 17 is a diagram illustrating the switching of a tactile sense provider according to the rotation operation of a dial;

FIG. 18 is a diagram illustrating the switching of a tactile sense provider according to the rotation operation of a dial;

FIG. 19 is a flowchart showing details of a tactile sense control process implemented by the tactile control unit of the sixth embodiment; and

FIG. 20 is a block diagram showing an electric configuration of a display manipulation device according to the sixth embodiment.

### EMBODIMENTS FOR CARRYING OUT INVENTION

Hereinafter, description will be given of the multiple embodiments of the present disclosure with reference to the drawings. The same reference numerals are assigned to the corresponding elements in the embodiments, and repeated descriptions thereof may be omitted. When only a portion of a configuration in each embodiment is described, with respect to other portions of the configuration, configurations of other embodiments that have been described can be applied. In addition to the combinations of configurations clearly depicted in the explanation of the embodiments, as long as problems do not particularly arise in a combination, the configurations of multiple embodiments may be partially combined with each other, even when not clearly described. Combinations not explicitly described of configurations described in multiple embodiments and modifications are also disclosed by the following description.

### First Embodiment

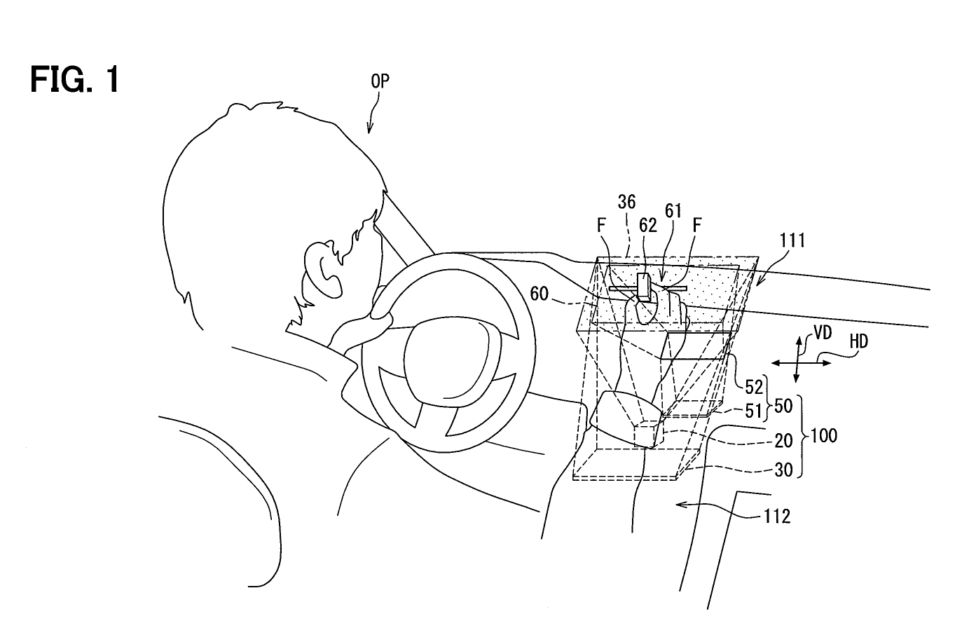

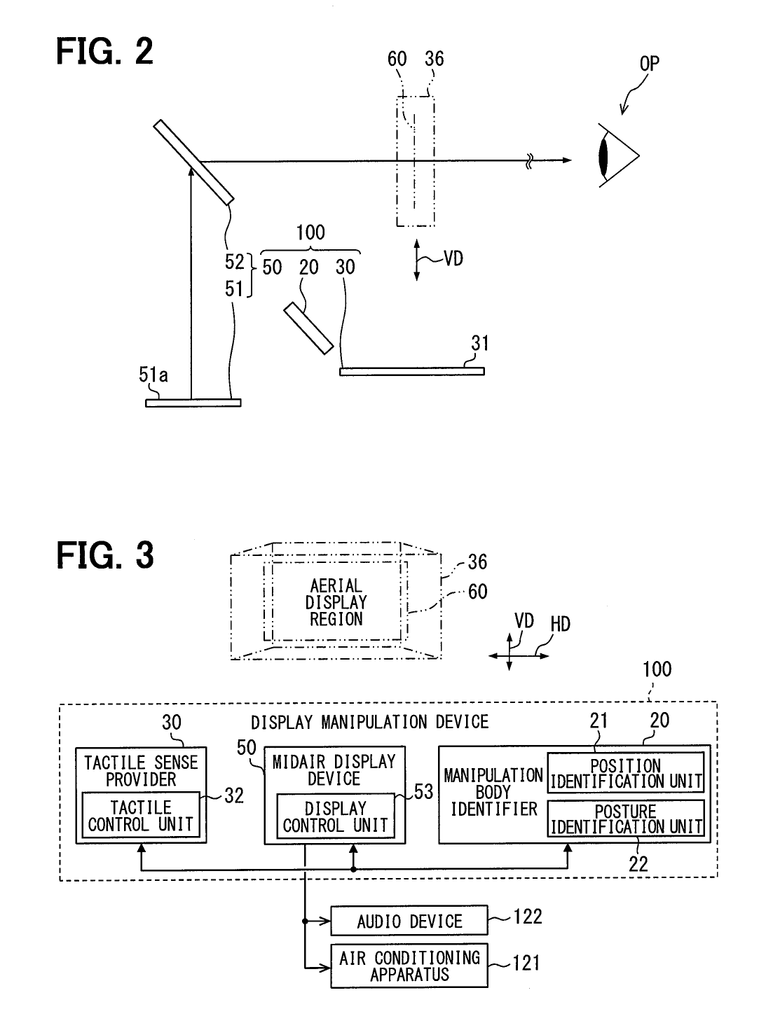

A display manipulation device 100 according to a first embodiment of the present disclosure shown in FIGS. 1 and 2 is installed in a vehicle and functions as a vehicle user interface that accepts the manipulation to operate other vehicle-mounted devices, such as an air conditioning apparatus 121 (refer to FIG. 3) and an audio device 122 (refer to FIG. 3). Each configuration of the display manipulation device 100 is accommodated in a center cluster 111 and a center console 112. The display manipulation device 100 displays an image of a manipulation target 61 on a virtual aerial display region 60 (refer to a dot area in FIG. 1) defined in a rectangular planar shape. The aerial display region 60 is defined in midair above the center console 112 and behind the center cluster 111. A driver sitting in a driver's seat, an occupant sitting in a front passenger seat, and so on can manipulate, as an operator OP an image of the virtual manipulation target 61 displayed in the midair between the driver's seat and the front passenger seat.

As shown in FIGS. 1 to 3, the display manipulation device 100 includes a manipulation body identifier 20, a tactile sense provider 30, and a midair display device 50. The manipulation body identifier 20, the tactile sense provider 30, and the midair display device 50 are electrically connected to each other, and can mutually exchange information with each other. The display manipulation device 100 can output manipulation information input by the operator OP or the like to another vehicle-mounted device.

In the following description, it is assumed that a longitudinal direction of the virtual aerial display region 60 is a horizontal direction HD, and a direction perpendicular to the horizontal direction HD along the aerial display region 60 is a vertical direction VD. In addition, it is assumed that a side of the aerial display region 60 which is closer to a front side of the vehicle is defined as a back side of the aerial display region 60, and a side of the aerial display region 60 which is closer to a rear side of the vehicle is defined as a front side of the aerial display region 60.

The manipulation body identifier 20 has a configuration including, for example, an infrared camera or the like, and detects a state of an manipulation body (such as finger F) that operates an image of the manipulation target 61. In the present application, finger also includes a thumb. The manipulation body identifier 20 is disposed above and within a space range corresponding to the tactile sense provider 30. The manipulation body identifier 20 can detect the state of the manipulation body in a three-dimensional space including at least the aerial display region 60 and surrounding space of the aerial display region 60.

The manipulation body identifier 20 includes a position identification unit 21 and a posture identification unit 22. The position identification unit 21 analyzes an image captured by the infrared camera to identify the position of the finger F in the aerial display region 60. The posture identification unit 22 analyzes the image captured by the infrared camera to identify the posture of the finger F in the aerial display region 60.

The tactile sense provider 30 is formed in a plate-like shape as a whole and is disposed below the aerial display region 60. The tactile sense provider 30 has an ultrasonic generation portion 31 and a tactile control unit 32. The ultrasonic generation portion 31 is formed by two-dimensionally arranging multiple vibrators that oscillate ultrasonic waves. The tactile sense provider 30 is fixed to the center console 112 so that a posture of the ultrasonic generation portion 31 faces the aerial display region 60. The ultrasonic generation portion 31 generates a tactile stimulus on the manipulation body in a tactile sense providing region 36 using a pressure generated by an ultrasonic vibrator. The tactile sense providing region 36 is a three-dimensional space including at least the aerial display region 60 and the surrounding space of the aerial display region 60, and is substantially equal to an area in which the manipulation body identifier 20 can detect the manipulation body.

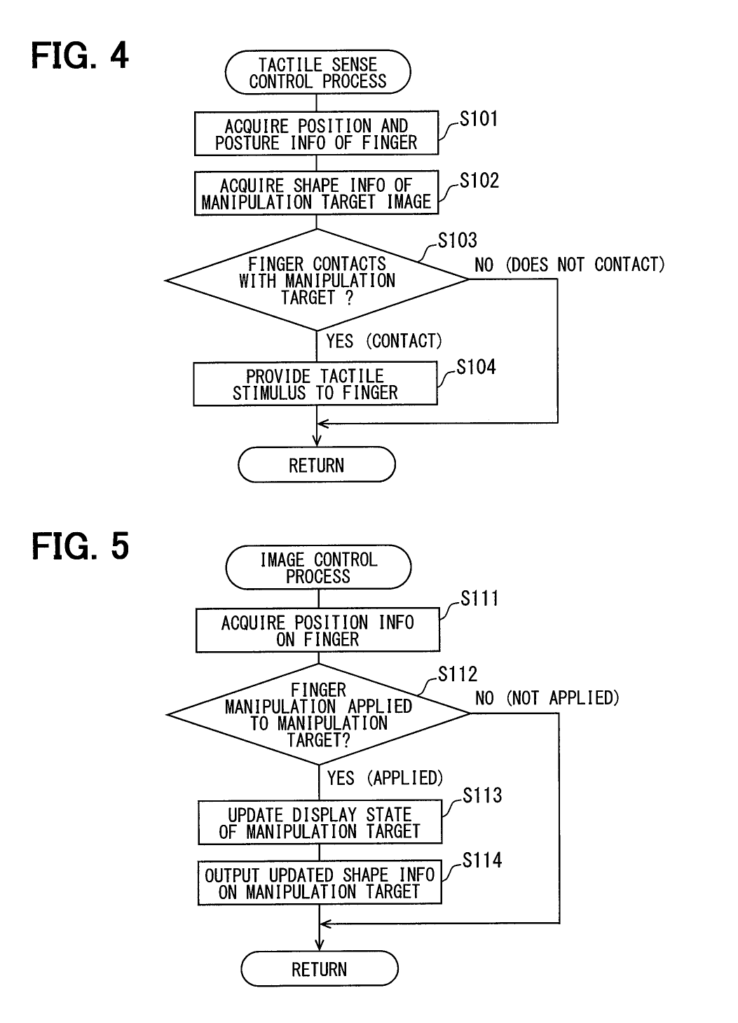

The tactile control unit 32 controls the tactile stimulus to be applied to the manipulation body by coordinating the multiple ultrasonic vibrators. The tactile control unit 32 repeatedly performs a tactile sense control process (refer to FIG. 4). The tactile control unit 32 acquires information on the position and posture of the finger F from the manipulation body identifier 20 (refer to S101 in FIG. 4) and acquires the shape information on the manipulation target 61 from the midair display device 50 (refer to S102 in FIG. 4). The tactile control unit 32 determines whether the manipulation body such as the finger F is in contact with the image of the manipulation target 61, or not, based on the acquired information, (refer to S103 in FIG. 4). When an affirmative determination is made that the finger F is in contact with the manipulation target 61, the tactile control unit 32 provides the tactile stimulus to the finger F or the like in a non-contact manner (refer to S104 in FIG. 4).

The midair display device 50 has a liquid crystal panel 51, a reflector 52, and a display control unit 53. The liquid crystal panel 51 includes a display panel and a backlight. The display panel is provided by a display surface 51a, and the backlight illuminates the display panel in a transmissive manner. The liquid crystal panel 51 can continuously form an image based on the image data successively acquired from the display control unit 53 on the display surface 51a, thereby being capable of displaying a full color image. The liquid crystal panel 51 is disposed below the reflector 52 and is fixed in the center cluster 111 or the center console 112 so that the display surface 51a faces the reflector 52.

The reflector 52 is formed in a plate-like shape as a whole and is disposed above the liquid crystal panel 51. The reflector 52 is a so-called two-plane perpendicular reflector, and is configured by an optical element in which multiple micro-mirrors are arranged in an array. More specifically, the reflector 52 is formed in a lattice shape, and defines multiple micro through holes. Each through hole has a square hole shape. Each side surface defining the through hole is provided by a mirror surface and forms the micro-mirror described above. The respective micro-mirrors are perpendicular to each other.

According to the configuration described above, a part of the light emitted from the display surface 51a is reflected by two micro-mirrors that are mutually perpendicular to each other, and generated as a real image in midair at a position opposite to the liquid crystal panel 51 with respect to the reflector 52. A two-dimensional imaging plane that includes the image of the display surface 51a is defined in advance as the aerial display region 60. The operator OP can view the image of the manipulation target 61 displayed in the aerial display region 60 of the midair with naked eyes.

The display control unit 53 controls multiple pixels provided on the liquid crystal panel 51, to thereby control the display manner of the image displayed on the display surface 51a, and consequently the display manner of the real image formed in the aerial display region 60. The display control unit 53 repeatedly executes an image control process (refer to FIG. 5) for changing the display manner of the manipulation target 61 in accordance with the manipulation input by the finger F. The display control unit 53 acquires the position information of the finger F from the manipulation body identifier 20 (refer to S111 in FIG. 5), and determines whether there is the manipulation input by the finger F or the like on the manipulation target 61, or not, based on the acquired information (refer to S112 in FIG. 5). When it is determined that there is the manipulation input, the display control unit 53 updates the display state of the manipulation target 61 according to the manipulation input by the finger F (refer to S113 in FIG. 5). Further, the display control unit 53 outputs the updated shape information of the manipulation target 61 to the tactile sense provider 30 (refer to S114 in FIG. 5), and also outputs a command signal based on the manipulation made by the finger F to the external vehicle-mounted device.

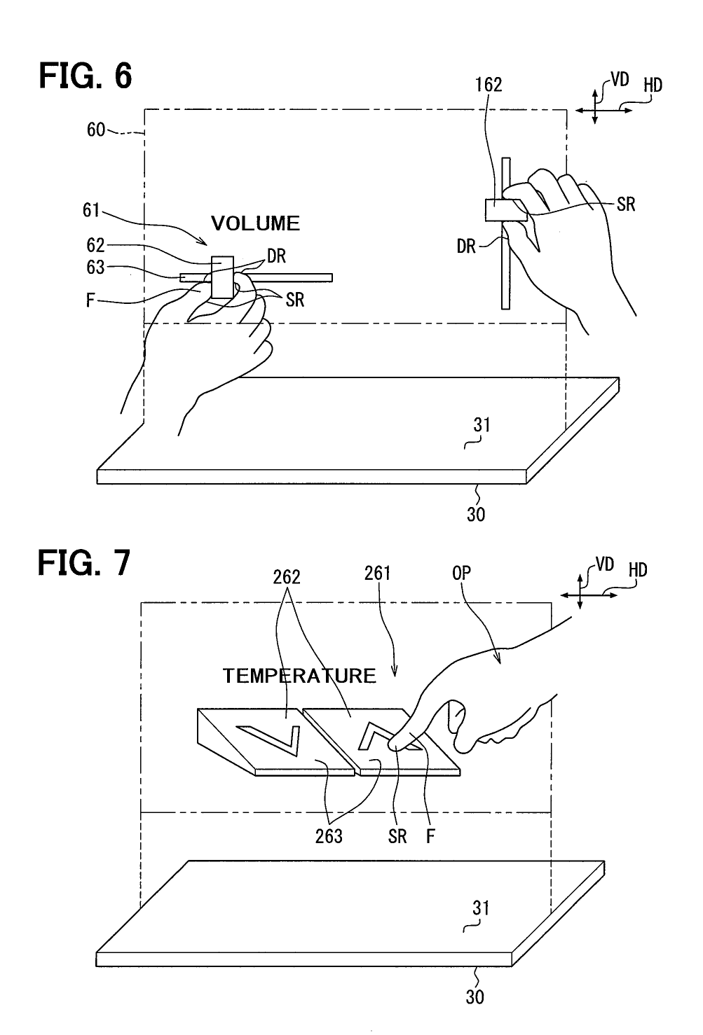

Next, the details of the manipulation target 61 in the first embodiment will be described with reference to FIG. 6 and FIG. 1.

The image of the manipulation target 61 is in a display mode for inducing the state of the finger F such that a high sensitivity portion SR with a high sensitivity to the tactile stimulus in the finger F of the operator OP is oriented in a direction susceptible to the tactile stimulus generated by the tactile sense provider 30. For example, the image of the manipulation target 61 is displayed downward. It is presumed that receptors that function as biosensor sensors such as Meissner's corpuscle located right under the skin and Merkel cells present in the epidermis are distributed at a high density in the high sensitivity portion SR. In the first embodiment, it is assumed that a region from a pulp to a side end of a fingertip is the high sensitivity portion SR, and the other portion of the finger F is the low sensitivity region DR.

The image of the manipulation target 61 includes a knob portion 62 that is movable in the horizontal direction HD and a slider groove portion 63 that shows a movable range of the knob portion 62. When the manipulation of sliding the knob portion 62 in the horizontal direction HD is made on the image displayed in midair by the operator OP, the display control unit 53 moves the knob portion 62 along the slider groove portion 63. The operator OP can change, for example, a volume of an audio device, a temperature of an air conditioning apparatus, and so on by the slide manipulation of the knob portion 62.

A movable direction of the knob portion 62 according to the first embodiment is defined along a planar direction of the ultrasonic generation portion 31. Therefore, when trying to move the knob portion 62 in the horizontal direction HD along the slider groove portion 63, the operator OP sandwiches the knob portion 62 from both sides in the horizontal direction HD by the thumb and the index finger. As a result, the high sensitivity portions SR of the thumb and the index finger are directed downward at which the ultrasonic generation portion 31 is located. According to the above configuration, the operator OP reliably receives the tactile stimulus provided by the ultrasonic wave output from the ultrasonic generation portion 31 with the respective fingertips of the thumb and the index finger, and can feel a virtual tactile sensation as if sandwiching the knob portion 62.

For comparison, a knob portion 162 movable in the vertical direction VD is illustrated in FIG. 6. The knob portion 162 is movable in a direction perpendicular to the plate surface direction of the ultrasonic generation portion 31. When the knob portion 162 is to be moved in the vertical direction VD, the operator OP grips the knob portion 162 from above and below using the thumb and the index finger. As a result, the thumb is in a state in which the back of the finger which is a low sensitivity region DR faces downward where the ultrasonic generation portion 31 is located. Furthermore, the high sensitivity portion SR of the index finger is blocked from the ultrasonic generation portion 31 by the thumb. According to the above configuration, the operator OP is unlikely to receive the tactile stimulus provided by the ultrasonic wave on the respective fingertips of the thumb and the index finger.

Furthermore, when the manipulation of moving the knob portion 62 is performed, the tactile sense provider 30 adjusts a strength level of the tactile stimulus provided to each of the thumb and the index finger. Specifically, between the two fingertips that sandwich the knob portion 62a, stronger tactile stimulus is generated for the fingertip on the rear side in the moving direction, compared with the fingertip on the front side in the moving direction.

Specifically, when the knob portion 62 is slid toward the driver's seat, a stronger tactile stimulus is provided to the fingertip of the index finger more than the fingertip of the thumb. On the contrary, when the knob portion 62 is slid toward the front passenger seat, the stronger tactile stimulus is provided to the fingertip of the thumb more than the fingertip of the index finger. As described above, the operator OP can feel, on the fingertip, a virtual resistance for moving the knob portion 62.

According to the first embodiment described above, the posture of the finger F of the operator OP is induced or guided by the image of the manipulation target 61 displayed in midair. Thus, the high sensitivity portion SR with the high sensitivity to the tactile stimulus in the finger F of the operator OP can be oriented in a direction susceptible to the tactile stimulus generated by the tactile sense provider 30. Therefore, even with the tactile stimulus provided in a non-contact manner, the certainty that the operator feels the tactile stimulus is improved. According to the configuration described above, the display manipulation device 100 can reliably give the feeling of manipulation to the operator OP who operates the image of the insubstantial manipulation target 61 displayed in midair.

In addition, as in the first embodiment, when the knob portion 62 that is slidable in the horizontal direction HD is displayed along the ultrasonic generation portion 31, the operator OP needs to sandwich the knob portion 62 from both sides in the horizontal direction HD with the fingers F. As a result, the high sensitivity portion SR of each finger F faces the ultrasonic generation portion 31. Therefore, the tactile sense provider 30 can apply the tactile stimulus to the high sensitivity portion SR of each fingertip sandwiching the knob portion 62 so as to make the operator OP feel as if sandwiching the knob portion 62 in reality.

Further, according to the first embodiment, the high sensitivity portion SR can also feel the strength level of the tactile stimulus with a high sensitivity. Therefore, when two tactile stimulus having different strength levels are provided to the two fingertips sandwiching the knob portion 62, the tactile sense provider 30 can make the operator OP feel the tactile sensation with reality as if the knob portion 62 pushes the rear side of the moving direction to perform the slide manipulation.

The finger F in the first embodiment corresponds to the “manipulation body”, the position identification unit 21 corresponds to the “position identifier”, the posture identification unit 22 corresponds to the “posture identifier”, the ultrasonic generation portion 31 corresponds to the “generation portion”, and the knob portion 62 corresponds to the “contact portion”.

### Second Embodiment

A second embodiment according to the present disclosure shown in FIG. 7 is a modification of the first embodiment. An image of a manipulation target 261 according to the second embodiment includes multiple push buttons 262. The multiple push buttons 262 are aligned in a horizontal direction HD along an ultrasonic generation portion 31. Each of the push buttons 262 is provided with a pressing surface 263 directed to an operator OP. The pressing surface 263 is slightly inclined upward toward a back side. Due to the inclination of the pressing surface 263, each push button 262 can be recognized by the operator OP as an input unit capable of being pushed downward where the tactile sense provider 30 is located.

When a push manipulation directed downward is entered by each push button 262, a display control unit 53 (refer to FIG. 3) displays an image in which the push button 262 that has entered the manipulation is pushed down. In addition, the tactile control unit 32 (refer to FIG. 3) provides a tactile stimulus to a fingertip of a finger F that touches the pressing surface 263, and also performs a control to strengthen the tactile stimulus to be generated according to the timing of pushing each push button 262. According to the above configuration, the operator OP can feel a virtual pushing feeling of the button associated with the push manipulation.

Also in the second embodiment described above, the same advantages as those of the first embodiment can be obtained. As a result, a state of the finger F is induced by the image of the manipulation target 261, and the operator OP can reliably feel the manipulation feeling when manipulating the image of the insubstantial manipulation target 261.

In addition, in the second embodiment, the operator OP is induced by the shape of each push button 262. As a result, the operator OP is supposed to perform the push manipulation such that a pulp portion of the finger F, which is a high sensitivity portion SR, is directed toward the ultrasonic generation portion 31. As a result, the tactile sense provider 30 can provide the tactile stimulus to the pulp portion of the finger F, and enables the operator to feel the feeling of pushing the push button 262. The push button 262 in the second embodiment corresponds to the “push button portion”.

### Third Embodiment

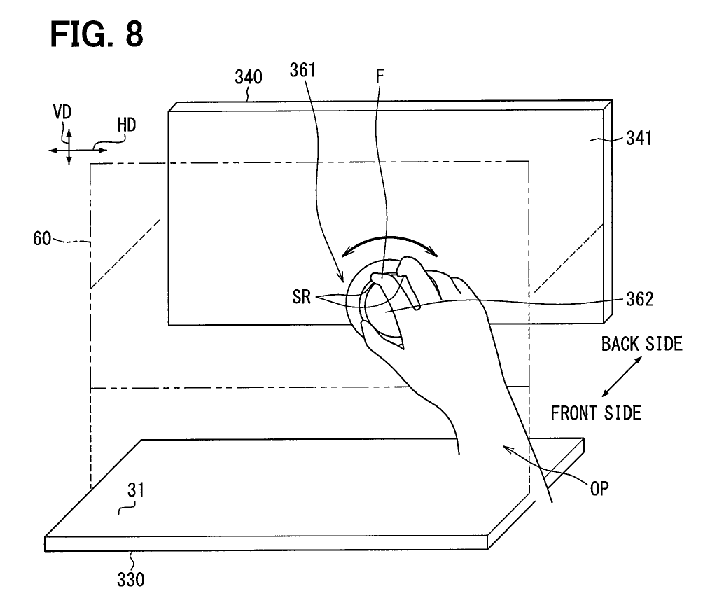

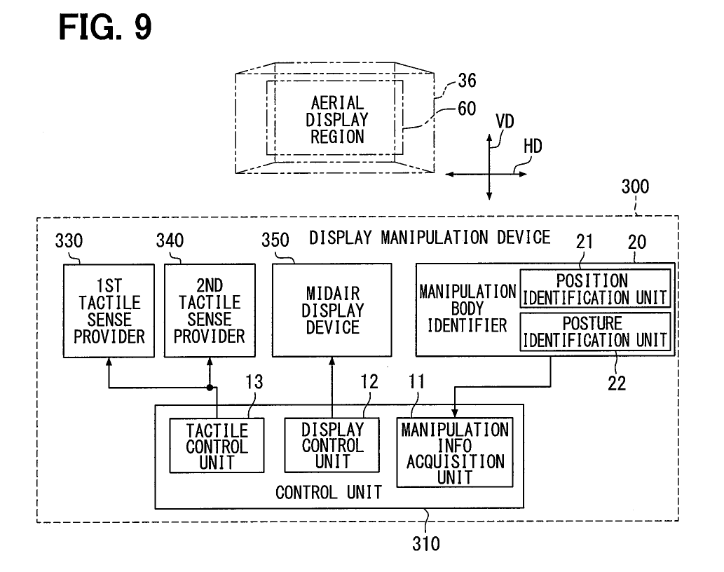

A third embodiment according to the present disclosure illustrated in FIGS. 8 and 9 is another modification of the first embodiment. A display manipulation device 300 according to the third embodiment includes a manipulation body identifier 20, a first tactile sense provider 330, a second tactile sense provider 340, a midair display device 350, and a control unit 310.

The first tactile sense provider 330 has a configuration similar to the tactile sense provider 30 according to the first embodiment. The tactile control unit 32 (refer to FIG. 3) included in the first tactile sense provider 330 is not shown. The first tactile sense provider 330 is disposed below an aerial display region 60 and can provide a tactile stimulus to a manipulation body such as a finger F that is present in a tactile sense providing region 36.

The second tactile sense provider 340 has substantially the same configuration as that of the first tactile sense provider 330, and is disposed on a back side of an aerial display region 60 separately from the first tactile sense provider 330. An ultrasonic generation portion 341 of the second tactile sense provider 340 is directed to the aerial display region 60 similarly to the ultrasonic generation portion 31 of the first tactile sense provider 330. The ultrasonic generation portion 341 can provide the tactile stimulus to the manipulation body, such as the finger F or palm, which is present in the tactile sense providing region 36 defined on a front side close to the operator, in a direction different from that of the first tactile sense provider 330.

The midair display device 350 has a configuration similar to the midair display device 50 (refer to FIG. 3) of the first embodiment. The display control unit 53 (refer to FIG. 3) included in the midair display device 350 is not shown. A reflector 52 (refer to FIG. 2) of the midair display device 350 is disposed so that the reflector 52 does not overlap with the second tactile sense provider 340 in a vertical direction VD.

The control unit 310 is electrically connected to the manipulation body identifier 20, the first tactile sense provider 330, the second tactile sense provider 340, and the midair display device 350. The control unit 310 of the display manipulation device 300 is electrically connected to an external vehicle-mounted device, and outputs manipulation information to the external vehicle-mounted device. The control unit 310 mainly includes a microcomputer having a processor, a RAM, and a memory.

The control unit 310 controls the processor to execute a predetermined program, to thereby implement a manipulation information acquisition unit 11, a display control unit 12, and a tactile control unit 13 as functional blocks. The manipulation information acquisition unit 11 acquires information indicative of the position and posture of the manipulation body from the position identification unit 21 and the posture identification unit 22. The display control unit 12 executes a process similar to the display control unit 53 (refer to FIG. 3) of the first embodiment, and controls the image displayed in the aerial display region 60. The tactile control unit 13 has function similar to the tactile control unit 32 (refer to FIG. 3) of the first embodiment, and controls the tactile stimulus applied to the manipulation body from each of the two tactile sense providers 330 and 340.

Next, the details of the image displayed in the aerial display region 60 of the midair by the display manipulation device 300 will be described.

One of menu screen groups configured in a multilayered manner, an image of the manipulation target 361, and the like are displayed in the aerial display region 60. The menu screen group includes at least, for example, an air conditioning menu screen for accepting a manipulation on an air conditioning apparatus 121, an audio menu screen for accepting a manipulation on an audio device 122, and a main menu screen which is a higher hierarchy compared with the air conditioning menu screen and the audio menu screen. The operator OP performs the manipulation of selecting and determining one of multiple icons displayed on the main menu screen, thereby being capable of transitioning the display from the main menu screen to the lower hierarchy menu screen, such as the air conditioning menu screen or the audio menu screen.

The image of the manipulation target 361 includes at least one rotatable dial 362. The dial 362 is displayed in the aerial display region 60 in a posture such that a virtual rotation axis intersects with the aerial display region 60. For example, the rotation axis of the dial 362 in the third embodiment is substantially perpendicular to the aerial display region 60. Due to the display mode of the image of the manipulation target 361, the operator OP grips the dial 362 with multiple fingers F from above and is induced to rotate the dial 362 in any direction.

When a counterclockwise rotation manipulation is applied to the image of dial 362 by the operator, the display control unit 12 displays the image of the dial 362 such that the dial 362 rotates counterclockwise, based on the information output from the position identification unit 21 and the posture identification unit 22 to the manipulation information acquisition unit 11. Likewise, when a clockwise rotation manipulation is applied to the image of dial 362 by the operator, the image of the dial 362 is displayed such that the dial 362 rotates in the clockwise direction. According to such a rotation manipulation, the operator OP can sequentially switch an icon selected in the menu screen to another one. Further, the tactile stimulus is provided to the fingertip of each finger F touching the dial 362 by the first tactile sense provider 330 controlled by the tactile control unit 13. As a result, the operator OP can feel the virtual tactile sensation as if grasping the dial 362.

In addition, when a pushing manipulation for pushing the dial 362 toward the back side along the rotation axis is applied to the dial 362, the display control unit 12 displays an image of the dial 362 which is displaced toward the back side. Further, when the selected icon is determined by pushing the dial 362, the display control unit 12 controls the hierarchy of the menu screen group to switch to another layer. Then, the second tactile sense provider 340 that is controlled by the tactile control unit 13 applies a tactile stimulus to the finger F and the palm by which the pushing manipulation is performed at the timing when the dial 362 is pushed. As a result, the operator OP can feel a virtual click feeling associated with the manipulation of pushing the dial 362.

Also in the third embodiment described above, the same advantages as those of the first embodiment can be obtained. As a result, the state of the finger F is induced by the image of the manipulation target 361, and the operator OP can reliably feel the manipulation feeling when manipulating the image of the insubstantial manipulation target 361.

In addition, also in the third embodiment, the high sensitivity portion SR of each finger F that grasps the dial 362 can be directed downward where the first tactile sense provider 330 is located. As described above, the first tactile sense provider 330 provides the tactile stimulus to a portion of the pulp of the finger F that grasps the dial 362, thereby being capable of reliably making the operator feel the feeling of grasping the dial 362.

In the third embodiment, the multiple tactile sense providers 330 and 340 can provide the tactile stimulus to the manipulation body from directions different from each other. Therefore, the display manipulation device 300 can cause the finger F to feel the respective virtual tactile sensations corresponding to the rotation manipulation and the push manipulation. As a result, the display manipulation device 300 can enable the operator OP, who performs complicated input such as switching the menu screen group structured in the multiple layers, to feel a sufficient manipulation feeling. The dial 362 in the third embodiment corresponds to a “dial portion”.

### Fourth Embodiment

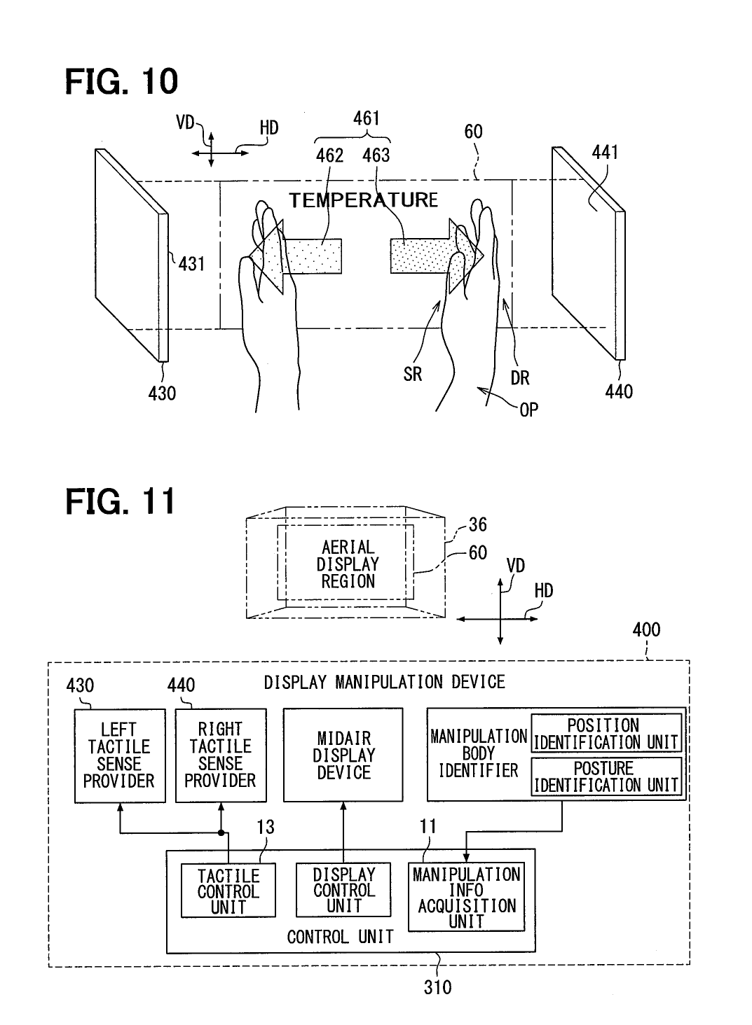

A fourth embodiment according to the present disclosure illustrated in FIGS. 10 and 11 is a modification of the third embodiment. A display manipulation device 400 according to the fourth embodiment includes a left tactile sense provider 430 and a right tactile sense provider 440 in place of the first tactile sense provider 330 and the second tactile sense provider 340 of the third embodiment. The tactile sense provider 430 and the tactile sense provider 440 are provided, respectively, on both sides of an aerial display region 60 in a horizontal direction HD, and are opposed to each other.

The left tactile sense provider 430 is disposed on a left side of the aerial display region 60. The left tactile sense provider 430 is fixed in a posture such that an ultrasonic generation portion 431 is directed to the aerial display region 60 located on a right side. The right tactile sense provider 440 is disposed on a right side of the aerial display region 60. The right tactile sense provider 440 is fixed in a posture such that an ultrasonic generation portion 441 is directed to the aerial display region 60 located on a left side. The ultrasonic generation portion 441 faces the ultrasonic wave generation portion 431 in the horizontal direction HD. Each of the tactile sense providers 430 and 440 can provide a tactile stimulus to a manipulation body that is present in a tactile sense providing region 36 defined between the two ultrasonic generation portions 431 and 441 from directions different from each other.

The image of the manipulation target 461 according to the fourth embodiment includes a set of guide display units 462 and 463. Each of the guide display units 462 and 463 guides, within the aerial display region 60, the manipulation of moving a manipulation body such as a hand in the horizontal direction HD. The direction of movement of the hand guided by the respective guide display units 462 and 463 is the same as the direction in which the two tactile sense providers 430 and 440 are aligned. Each of the guide display units 462 and 463 is an image imitating an arrow. The respective guide display units 462 and 463 are displayed side by side in the horizontal direction HD, and are directed opposite to each other.

One of the two guide display units located on the left side (left guide display unit 462) is an arrow pointing to the left, and is displayed in, for example, blue. The operator OP may move the hand to the left in the aerial display region 60, thereby being capable of lowering a set temperature of an air conditioning apparatus 121. The other (right guide display unit 463) located on the right side is an arrow pointing to the right direction and is displayed in red, for example. The operator OP may move the hand to the right in the aerial display region 60, thereby being capable of increasing the set temperature of the air conditioning apparatus 121. As described above, the operator OP is induced by the arrow-shaped guide display units 462 and 463 to perform the manipulation of moving the hand in the horizontal direction HD in the aerial display region 60. In the fourth embodiment, a palm of the hand is a high sensitivity portion SR, and a back of the hand is a low sensitivity region DR.

When a manipulation along the horizontal direction of the aerial display region 60 is input, a control unit 310 outputs a command signal instructing a change in the set temperature to the air conditioning apparatus 121 (refer to FIG. 3). In addition, a tactile control unit 13 controls the left tactile sense provider 430 and the right tactile sense provider 440 to generate the tactile stimulus on the palm of the hand and the back of the hand. According to the above configuration, the operator OP can sense a virtual resistance feeling.

In addition, the tactile control unit 13 can detect an orientation of the palm of the hand based on the information acquired by a manipulation information acquisition unit 11. When the palm of the hand is oriented to the left, the tactile control unit 13 sets the output level of the tactile stimulus generated by the right tactile sense provider 440 to be higher than the output level of the tactile stimulus generated by the left tactile sense provider 430. With this configuration, the tactile stimulus provided to the low sensitivity region DR becomes stronger than the tactile stimulus provided to the high sensitivity portion SR. Thus, the operator OP can reliably feel the tactile sensation on both of the palm of the hand and the back of the hand. When the palm of the hand is oriented to the right, the tactile control unit 13 sets the output level of the tactile stimulus generated by the left tactile sense provider 430 to be higher than the output level of the tactile stimulus generated by the right tactile sense provider 440.

In addition, when the manipulation body moves close to each tactile sense provider 430, 440, the tactile control unit 13 generates a stronger tactile stimulus than that when the manipulation body moves away. For example, when the operator OP moves the hand in the left direction, the tactile control unit 13 strengthens the tactile stimulus output from the left tactile sense provider 430, and weakens the tactile stimulus output from the right tactile sense provider 440. As described above, the operator OP can feel the resistance feeling as if the operator OP is moving hands in a highly viscous fluid.

Also in the fourth embodiment described above, the same advantages as those of the first embodiment can be obtained. As a result, the orientation of the hand is induced by the image of the manipulation target 461, and the operator OP can reliably feel the manipulation feeling at least on the palm of the hand which is the high sensitivity portion SR.

In addition, according to the fourth embodiment, with the induction of the guide display units 462 and 463, the palm of the hand which is the high sensitivity portion SR can be induced to face one of the left and right tactile sense providers 430 and 440. As a result, the left tactile sense provider 430 or the right tactile sense provider 440 can provide the tactile stimulus to the palm of the hand disposed in the aerial display region 60, thereby being capable of causing the operator OP to feel resistance.

In addition, in the fourth embodiment, the tactile stimulus is provided to not only the palm of the hand but also the back of the hand, and the strength of the tactile stimulus is adjusted according to the movement direction of the hand. As described above, the tactile control unit 13 allows the operator OP who is performing the manipulation in the aerial display region 60 along the horizontal direction to feel a virtual resistance with the high reality. The left tactile sense provider 430 and the right tactile sense provider 440 in the fourth embodiment correspond to the “tactile sense provider”, and the horizontal direction HD corresponds to the “facing direction”.

### Fifth Embodiment

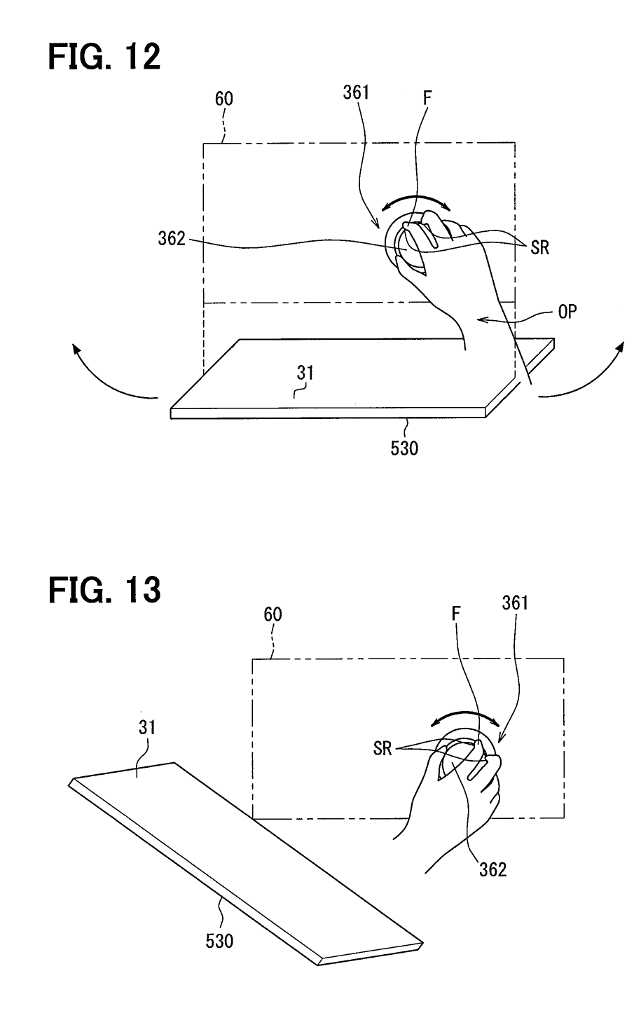

A fifth embodiment according to the present disclosure illustrated in FIGS. 12 to 15 is another modification of the third embodiment. A tactile control unit 513 of a display manipulation device 500 according to the fifth embodiment is electrically connected to a tactile sense provider 530 and a moving mechanism 580. The tactile sense provider 530 has substantially the same configuration as that of the first embodiment. The tactile sense provider 530 is movable around an aerial display region 60 while maintaining a posture in which an ultrasonic generation portion 31 is directed to the aerial display region 60.

The moving mechanism 580 changes a relative position of the tactile sense provider 530 relative to the aerial display region 60. The moving mechanism 580 can move the tactile sense provider 530 below the aerial display region 60. A movable range of the tactile sense provider 530 by the moving mechanism 580 is defined, for example, between a lower left and a lower right of the aerial display region 60. In the case where the posture of the hand is changed with the rotation manipulation of a dial 362 (refer to FIG. 13), the moving mechanism 580 moves the tactile sense provider 530 to a position where the tactile stimulus is easily provided to a high sensitivity portion SR. For example, when the manipulation of rotating the dial 362 in the clockwise direction is input, the tactile sense provider 530 rotates clockwise around the aerial display region 60.

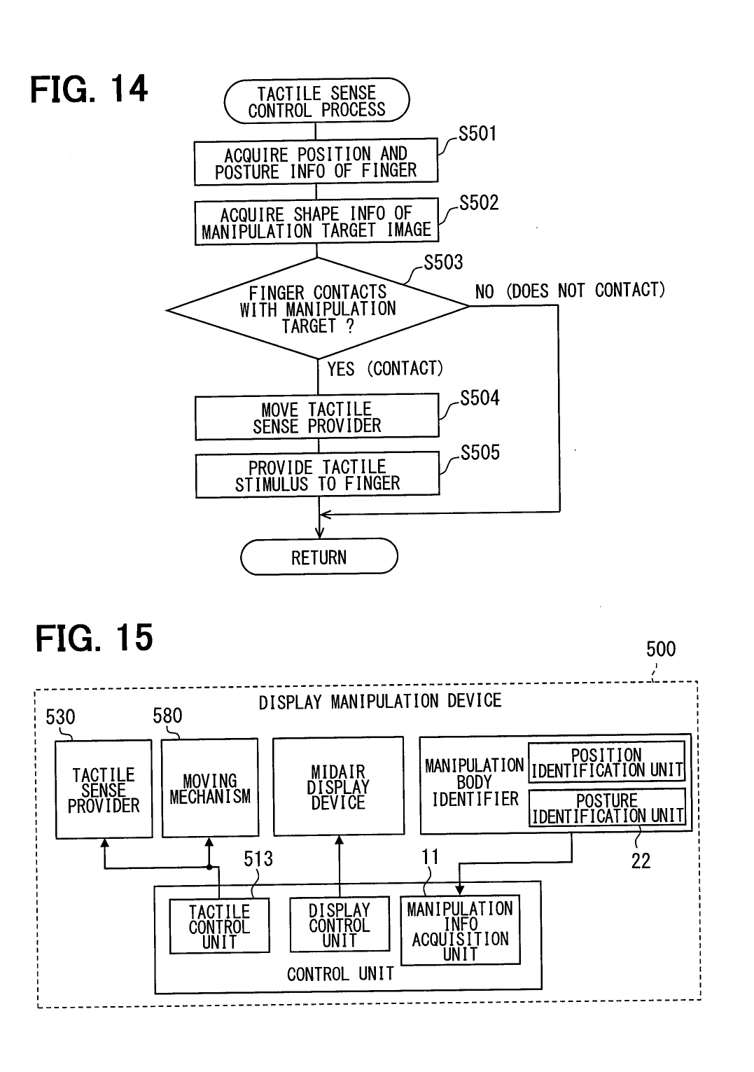

The tactile control unit 513 controls the generation of the tactile stimulus provided by the tactile sense provider 530, and controls the movement of the tactile sense provider 530 using the moving mechanism 580. The tactile control unit 513 determines whether the finger F touches the image of a manipulation target 361, or not, based on the information acquired from a manipulation information acquisition unit 11, with the implementation of the tactile sense control process (refer to S501 to S503 in FIG. 14). As a result, if an affirmative determination is made that the finger F touches the manipulation target 361, the tactile control unit 513 moves the tactile sense provider 530 to a position where the tactile stimulus is easily provided to the high sensitivity portion SR of the finger F, based on the posture of the finger F identified by a posture identification unit 22 (refer to S504 in FIG. 14). Then, the tactile control unit 513 provides the tactile stimulus to the high sensitivity portion SR of the finger F in a non-contact manner (refer to S505 in FIG. 14).

Also in the fifth embodiment described above, the same advantages as those of the third embodiment are obtained, and an operator OP can reliably feel the tactile feeling when manipulating the insubstantial dial 362. In addition, in the fifth embodiment, when the posture of the finger F changes during the rotating manipulation of the dial 362, the tactile sense provider 530 can continuously maintain a state in which the tactile stimulus is easily provided to the high sensitivity portion SR by adjusting the position using the moving mechanism 580. According to the above description, in the rotation manipulation of the dial 362, the operator OP can continuously feel the virtual feeling of grasping the dial 362.

### Sixth Embodiment

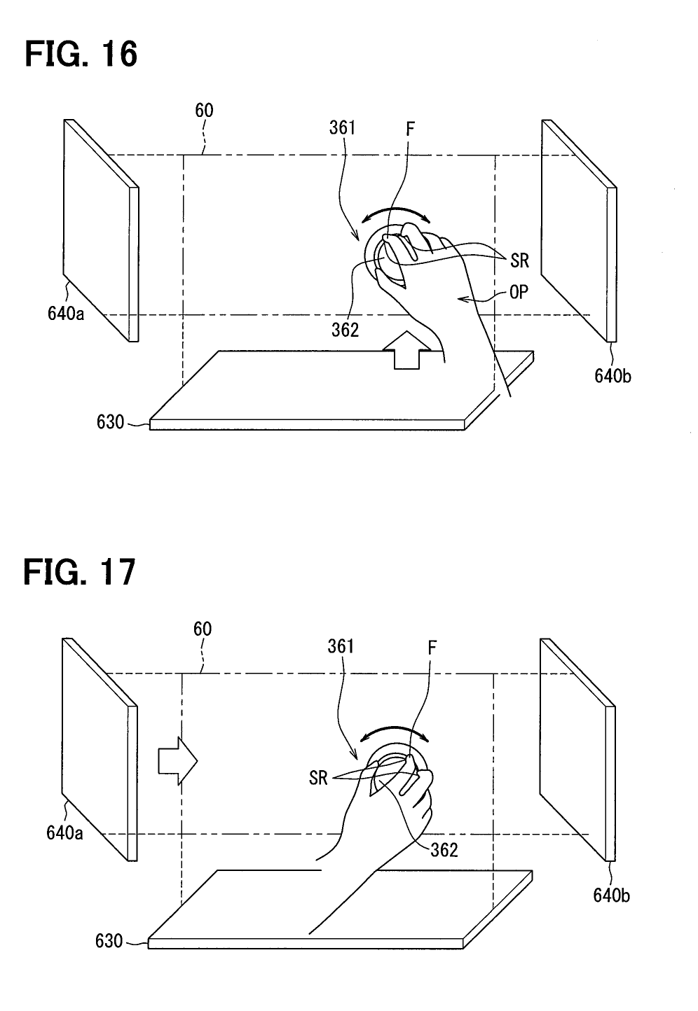

A sixth embodiment according to the present disclosure illustrated in FIGS. 16 to 20 is another modification of the third embodiment. A tactile control unit 613 of a display manipulation device 600 is electrically connected to multiple (three) tactile sense providers 630, 640a, and 640b provided at mutually different positions with respect to an aerial display region 60. The lower tactile sense provider 630 corresponds to the tactile sense provider 30 (refer to FIG. 6) of the first embodiment, and generates a tactile stimulus from lower side of the aerial display region 60. The left tactile sense provider 640a corresponds to the left tactile sense provider 430 (refer to FIG. 10) of the fourth embodiment, and generates the tactile stimulus from the left side of the aerial display region 60. The right tactile sense provider 640b corresponds to the right tactile sense provider 440 (refer to FIG. 10) of the fourth embodiment, and generates the tactile stimulus from the right side of the aerial display region 60.

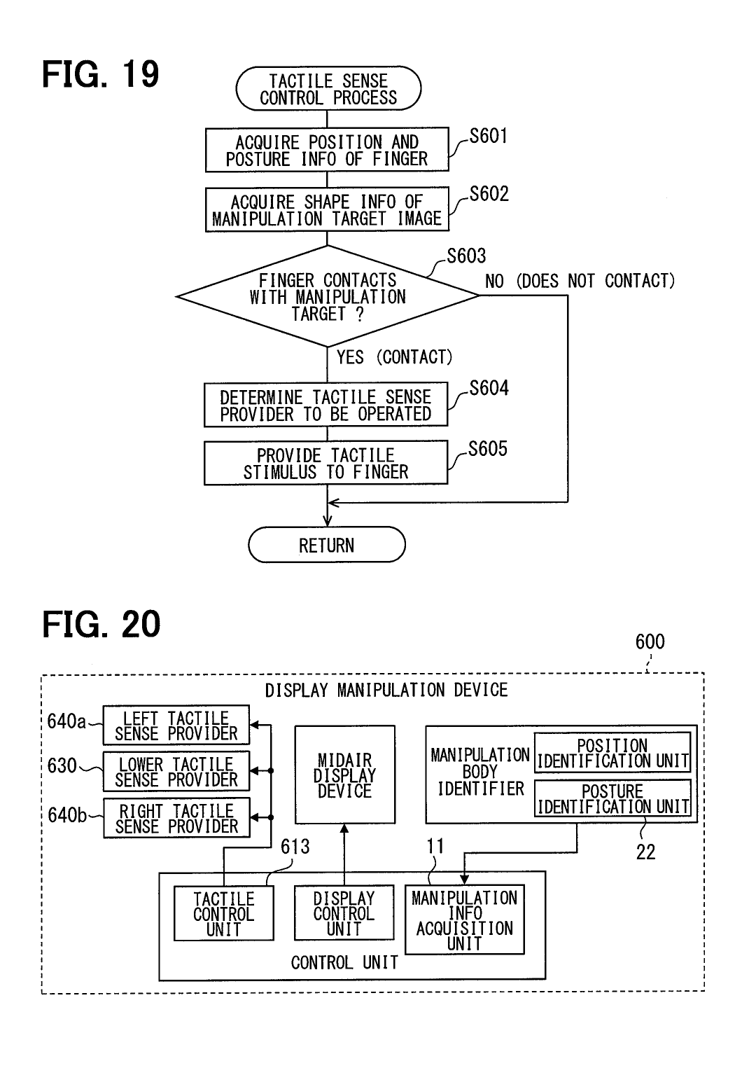

The tactile control unit 613 determines whether the finger F touches the image of the manipulation target 361, or not, based on the information acquired from a manipulation information acquisition unit 11, with the implementation of the tactile sense control process (refer to S601 to S603 in FIG. 19). When an affirmative determination is made that the finger F touches the manipulation target 361, the tactile control unit 613 selects a tactile sense provider to be operated (refer to S604 in FIG. 19). More specifically, the tactile control unit 613 determines at least one of the multiple tactile sense providers 630, 640a, and 640b, which is disposed at a position where a tactile stimulus is easily applied to a high sensitivity portion SR as a tactile sense provider to be operated, based on the posture of the finger F identified by a posture identification unit 22. Then, the tactile stimulus is provided to the high sensitivity portion SR of the finger F in a non-contact manner by the tactile sense provider to be operated (refer to S605 in FIG. 19).

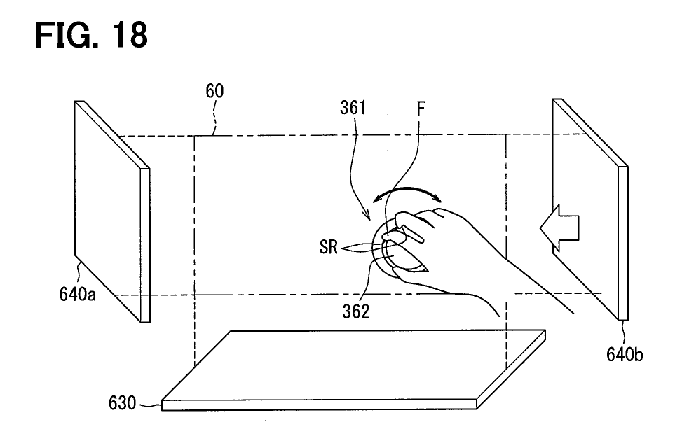

According to the above description, in an initial state in which a virtual dial 362 is gripped from upper side, a tactile stimulus is mainly applied to the finger F by the tactile sense provider 630 disposed on lower side (refer to FIG. 16). When the manipulation of rotating the dial 362 in the clockwise direction is applied to the virtual dial 362, a tactile stimulus is mainly provided to the finger F by the tactile sense provider 640a disposed on left side (refer to FIG. 17). When the manipulation of rotating the dial 362 in the counterclockwise direction is applied to the virtual dial 362, a tactile stimulus is mainly provided to the finger F by the tactile sense provider 640b disposed on right side (refer to FIG. 18).

Also, in the sixth embodiment described above, the same advantages as those of the third embodiment are obtained, and an operator OP can reliably feel the manipulation feeling when manipulating the insubstantial dial 362. In addition, in the sixth embodiment, even if the posture of the finger F changes in the course of the operation of rotating the dial 362, the tactile stimulus continues to be provided to the high sensitivity portion SR under a cooperative control of the multiple tactile sense providers by the tactile control unit 613. According to the above description, in the rotation manipulation of the dial 362, the operator OP can continuously feel the virtual feeling of grasping the dial 362.

### Other Embodiments

In the above description, multiple embodiments of the present disclosure are described. However, the present disclosure is not interpreted to be limited to the embodiments, and various embodiments and combinations thereof may be applied within a scope which does not depart from the spirit of the present disclosure.

In a first modification, which is a modification of the first embodiment, a right tactile sense provider (refer to FIG. 10) may be provided in place of the tactile sense provider 30 (refer to FIG. 6) disposed on lower side. In such a configuration, a movable direction of a knob portion, that is, a direction of a slider groove portion is set to a vertical direction VD along an ultrasonic generation portion of the right tactile sense provider.

In a second modification, the second tactile sense provider 340 (refer to FIG. 8) described in the third embodiment may be omitted. Even in such second modification, a configuration corresponding to the first tactile sense provider 330 (refer to FIG. 8) provides a tactile stimulus to a high sensitivity portion of the finger from lower side of an aerial display region 60 and enables the operator to continuously feel the virtual feeling of gripping the dial.

As described above, the number and placement of the tactile sense providers can be appropriately changed according to the space that can be secured for the display manipulation device in the vehicle. The display mode of the image of the manipulation target can be appropriately changed so that the high sensitivity portion such as finger faces the tactile sense provider in a pictorial form of affordance so as to correspond to a relative position of the tactile sense provider to the aerial display region.

Each of the tactile sense providers in the above embodiments forms the ultrasonic generation portion by arraying the vibrators in a plate-like shape. Alternatively, the ultrasonic generation portion on which the vibrators are arrayed may be formed in a curved shape. Furthermore, when a tactile stimulus can be provided to the manipulation body such as the finger or the like, the tactile sense provider may not been configured with the use of the ultrasonic waves. For example, a device that provides the tactile stimulus to the manipulation body by emitting a converged airflow toward the manipulation body can be employed as the tactile sense provider.

The manipulation body identifier in the embodiment described above detects the position and posture of the finger and the like by analyzing the captured image of an infrared camera. Alternatively, other configurations capable of detecting the state of the manipulation body in the midair can be employed as the manipulation body identifier. For example, a stereo camera, a distance image camera of TOF (Time Of Flight) type, a high sensitivity capacitance sensor, and so on can be employed as a manipulation body identifier.

The midair display device in the above embodiment has a configuration that causes the operator to visually recognize the image formed in midair by the reflector 52 (refer to FIG. 2). Alternatively, in the case of a screenless aerial display capable of displaying the image in midair, the midair display device may be configured without the use of the reflector 52.

The specified position, shape, size, posture and the like of the aerial display region in the above embodiment can be appropriately changed. For example, the aerial display region may be a vertically elongated rectangular shape, a horizontally elongated oval shape, or the like. Further, the vertical direction VD and the horizontal direction HD of the aerial display region may be inclined with respect to the vertical direction and the width direction of the vehicle in a stationary state. For example, with the placement in which a front of the aerial display region is directed toward a headrest of the driver's seat, the image displayed in the aerial display region is easily seen by the operator sitting in the driver's seat.

In the display manipulation device according to the first embodiment, the operator can visually recognize the back side by transmitting the image displayed in the aerial display region. Therefore, in the display manipulation device, the aerial display region is located at a height close to the driver's eyes, thereby being capable of reducing a load on the visual line movement of the operator sitting in the driver's seat. On the other hand, in the display manipulation device according to the third embodiment, since the second tactile sense provider is located at the back side of the aerial display region, the operator hardly visually recognizes the far side of the aerial display region. Therefore, in the display manipulation device as in the third embodiment, it is desirable to position the aerial display region in the vicinity of the operator sitting in the driver's seat, for example, just above the center console.

The display manipulation device according to the above embodiment is directed to an interface that accepts the manipulations of air conditioning apparatuses, audio devices, and the like. However, the vehicle-mounted device that can be operated by input to the display manipulation device is not limited to the devices described above. Further, the menu screen displayed when manipulating the respective vehicle-mounted devices may be displayed in the aerial display region as in the above embodiment, or may be displayed in another display area such as a liquid crystal screen of a combination meter.

In the first embodiment and the like, the operator places the finger in the tactile sense providing region in order to manipulate the displayed knob portion. Therefore, the area from the pulp to the side of the finger is regarded as the high sensitivity portion, and induced to face the tactile sense provider. On the other hand, in the fourth embodiment, the operator places the entire hand in the tactile sense providing region. Therefore, the palm of the hand is set as the high sensitivity portion, and induced to face the tactile sense provider. As described above, according to the manipulation method assumed to input by the operator, an area to be set as the high sensitivity portion can be set appropriately. However, it is desirable that receptors that function as biometric tactile sensors are distributed with a higher density than other regions which are in the tactile sense providing region in the area that is set as the high sensitivity portion.

In the first embodiment and the like, the control unit is provided for each of the tactile sense provider and the midair display device. In the third embodiment and the like, the control units for controlling the tactile sense provider and the midair display device are provided together in one control unit. The functions provided by the respective control units as described above can be provided by hardware and software different from the above, or a combination of the hardware and the software. For example, the processor of the control circuit provided in the midair display device can perform the control of the tactile sense provider or the identification of the position and the posture of the manipulation body by analysis of the image analysis.

In the above embodiment, an example in which the present disclosure is applied to the display manipulation device for the vehicle has been described, but the application target of the present disclosure is not limited to the display manipulation device mounted on the vehicle. For example, in a display device according to the present disclosure, because the finger or the like do not touch a tangible object, such a display device is suitable for an interface of a medical device which is particularly strict in sanitation management. Furthermore, the display manipulation device according to the present disclosure is also suitable for an interface of a device to which the manipulation is input by an unspecified number of operators such as an automated teller machine.

While the disclosure has been described with reference to preferred embodiments thereof, it is to be understood that the disclosure is not limited to the preferred embodiments and constructions. The disclosure is intended to cover various modification and equivalent arrangements. In addition, the various combinations and configurations, which are preferred, other combinations and configurations, including more, less or only a single element, are also within the spirit and scope of the disclosure.

1. A display manipulation device enabling an operator to manipulate an image of a manipulation target displayed in midair, the display manipulation device comprising:
a midair display device that displays the image of the manipulation target in an aerial display region virtually defined in midair;
a position identifier that identifies a position of a manipulation body of the operator in the aerial display region; and
a tactile sense provider that provides a tactile stimulus to the manipulation body in a non-contact manner based on the identified position of the manipulation body when the position identifier determines that the manipulation body touches the image of the manipulation target, the tactile sense provider being disposed to have a posture angled with the aerial display region, wherein
the manipulation body of the operator has a high sensitivity portion, which is highly sensitive to the tactile stimulus, and a low sensitivity region, which is lower in sensitivity than the high sensitivity portion, and
the image of the manipulation target is displayed to induce a state of the manipulation body so that the high sensitivity portion of the manipulation body faces a direction susceptible to the tactile stimulus provided by the tactile sense provider.

2. The display manipulation device according to claim 1, wherein
the tactile sense provider includes a generation portion,
the generation portion is disposed to face the aerial display region and provides the tactile stimulus to the manipulation body,
the image of the manipulation target includes a contact portion that is movable along the generation portion, and
the midair display device displays the image of the manipulation target which includes the contact portion.

3. The display manipulation device according to claim 2, wherein,
when the operator performs a manipulation of moving the contact portion with two parts of the manipulation body by sandwiching the contact portion, the tactile sense provider generates a stronger tactile stimulus on one of the two parts of the manipulation body disposed on a rear side in a movement direction of the contact portion compared with a remaining one of the two parts of the manipulation body disposed on a front side in the movement direction.

4. The display manipulation device according to claim 1, wherein
the image of the manipulation target includes a push button portion that is pushable toward the tactile sense provider, and
the midair display device displays the image of the manipulation target which includes the push button portion.

5. The display manipulation device according to claim 1, wherein
the tactile sense provider is disposed below the aerial display region,
the image of the manipulation target includes a rotatable dial portion and the aerial display region has a planar shape,
the rotatable dial portion is disposed such that a virtual rotation axis of the rotatable dial portion intersects with the aerial display region, and
the midair display device displays the image of the manipulation target including the rotatable dial portion.

6. The display manipulation device according to claim 5, further comprising:
a posture identifier that identifies a posture of the manipulation body in the aerial display region; and
a moving mechanism that moves, based on the posture of the manipulation body identified by the posture identifier, the tactile sense provider to a position where the tactile stimulus is easily provided to the high sensitivity portion.

7. The display manipulation device according to claim 5, wherein the display manipulation device enables the operator to manipulate an image of a menu screen group having a multilayered hierarchy structure, and the tactile sense provider is referred to as a first tactile sense provider,
the display manipulation device further comprising:
a second tactile sense provider different from the first tactile sense provider, wherein the second tactile sense provider is disposed on a back side of the aerial display region,
wherein
the midair display device displays the rotatable dial portion that is configured to switch a hierarchy of the menu screen group in response to a pushing operation on the rotatable dial portion toward the back side of the aerial display region along the virtual rotation axis of the rotatable dial portion, and
the second tactile sense provider provides the tactile stimulus to the manipulation body when the pursing operation is made by the manipulation body on the rotatable dial portion toward the back side of the aerial display region.

8. The display manipulation device according to claim 5, further comprising:
a plurality of the tactile sense providers that are disposed at different positions from each other with respect to the aerial display region;
a posture identifier that identifies the posture of the manipulation body in the aerial display region; and
a tactile control unit that controls, based on the posture of the manipulation body which is identified by the posture identifier, the plurality of tactile sense providers so that at least one of the plurality of tactile sense providers which is disposed at a position where the tactile stimulus is easily provided to the high sensitivity portion provides the tactile stimulus to the manipulation body.

9. The display manipulation device according to claim 1, wherein
the tactile sense provider is disposed on one side of the aerial display region and another tactile sense provider is disposed on another side of the aerial display region so that the tactile sense provider faces the another tactile sense provider in a facing direction,
the midair display device displays the image of the manipulation target which includes a guide display unit, and
the guide display unit guides a moving of the manipulation body along the facing direction in the aerial display region.

10. The display manipulation device according to claim 9, wherein
one of the tactile sense provider or the another tactile sense provider, which is configured to provide the tactile stimulus to the low sensitivity region, generates the tactile stimulation having a higher strength level compared with a strength level of the tactile stimulus provided by the remaining tactile sense provider which is configured to provide the tactile stimulus to the high sensitivity portion.

11. The display manipulation device according to claim 9, wherein,
when the manipulation body moves toward the tactile sense provider, the tactile sense provider generates the tactile stimulus having a higher strength level compared with a strength level of the tactile stimulus generated when the manipulation body moves away from the tactile sense provider.
